(19) United States
(12) Patent Application Publication
(10) Pub. No.: US 2016/0162683 A1
(43) Pub. Date: Jun. 9, 2016

(54) PASSIVE SECURITY OF APPLICATIONS

(71) Applicant: HEWLETT PACKARD ENTERPRISE DEVELOPMENT LP, Houston, TX (US)

(72) Inventors: Jonathan David Gibson, Austin, TX (US); Stanley Neil Foster, Wixom, MI (US); Ronald MONSON, Locust Grove, GA (US); Harold S MERKEL, Houston, TX (US)

(21) Appl. No.: 14/893,644

(22) PCT Filed: May 29, 2013
(86) PCT No.: PCT/US2013/043027

§ 371 Date: Nov. 24, 2015

(51) Int. Cl. G06F 21/44; G06F 21/52; G06F 21/31

(52) U.S. Cl. CPC G06F 21/44; G06F 21/316; G06F 21/52; G06F 2221/2139

(57) ABSTRACT

Example embodiments disclosed herein relate to performing a security function on an application based on processed passive user information. Applications are associated with a passive security engine. Passive user information is monitored via inputs. The passive user information is processed. A security function is performed for at least two of the applications based on the processed passive user information.

### BACKGROUND

Service providers and manufacturers are challenged to deliver quality and value to consumers, for example by providing device security. Devices are used for a variety of tasks, for example, consuming content, voice communications, gaming, navigation, etc. Users of devices may wish to secure these devices from others.

### BRIEF DESCRIPTION OF THE DRAWINGS

The following detailed description references the drawings, wherein:

FIG. 1 is a block diagram of a system including a computing device for performing a security function on applications, according to one example;

FIG. 2 is a black diagram of device capable of performing a security function on applications, according to one example;

FIG. 3 is a flowchart of a method for performing a security function for applications, according to one example; and

FIG, 4 is a flowchart of a method for processing passive user information for performing a security function, according to one example.

### DETAILED DESCRIPTION

Devices can be used to make and/or provide content to users. Some users or entities may wish to secure information on the devices. For example, a business may wish to protect information from being seen by other individuals outside of a user, or the user may wish for certain content to be protected by others. The security desired may be more specific than a model where users sign in with a set of credentials and the credentials can be used until expired.

Accordingly, various embodiments disclosed herein relate to ensuring that an end user using a secured resource is the same end user that initially authenticated to the secured resource by implicitly/passively authenticating the end user on defined intervals, random intervals, based on interrupts, etc. based on implicit/passive security information, such as facial recognition, print recognition (e.g., palm print, finger print, etc.), retina information, voice recognition, gait, heart signals, brain signals, typing rhythms, user keys, combinations thereof, etc. In some examples, when one or more users are tied to a device, the passive authentication can be used as a primary authentication for the device.

The passive authentication can ensure that the user accessing a secured resource is the same end user that initially authenticated the secured resource. Continuous authentication can be used to ensure security when the user leaves the area or a new user accesses content on the device. In some examples, it may not be secure to allow the new user access certain content on the device. As such, a security function can be performed based on the determination of a likelihood that the current user may be different than the user that provided security credentials. In some examples, different security functions for different applications may be performed based on the same information. The different security functions can include a negative security function such as limiting or removing access to an application or content, a neutral security function, such as requesting further authentication for the content/application, requesting a more thorough check from a passive security engine, etc., or a positive security function, such as keep allowing access to an application and/or content, etc.

In some examples, a passive security engine is a means to process information to determine the likelihood of security. The likelihood could be for an application, for particular content, etc. Further, the likelihood can be signified using a score, a value, a confidence level, a Boolean value, or the like. The passive security engine can be located on the device performing the security function or be located on another device (e.g., a server or other platform).

Moreover, one or more inputs connected to the device, integrated into the device, or the like can be used to generate the passive information to be processed. Drivers can be installed on the device to seamlessly connect to the respective input devices. Further a program on the device can control which input devices are used to gather security credentials and/or when to use the input devices. Moreover, the program can determine what combination of devices is available and/or which devices to use.

With the approaches described herein, the situation where one end user authenticates to a security sensitive resource via a device and then allows a second unauthenticated user to view/use the security sensitive resource via the device can be caught. Further, the approach can allow for the second user to access the device, where the content is not as sensitive.

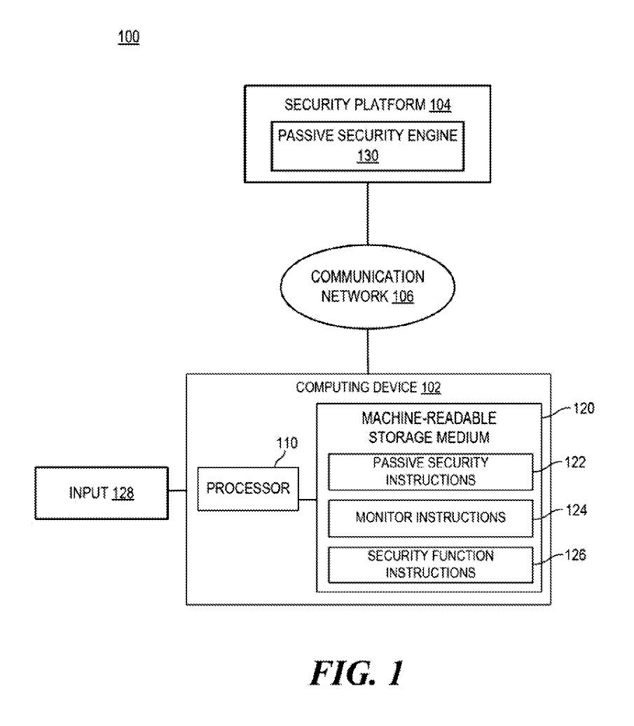

FIG. 1 is a block diagram of a system including a computing device for performing a security function on applications, according to one example. The system 100 can include a computing device 102 that communicates with other devices, such as a security platform 104, via a communication network 106. In certain examples, the computing device 102 and/or the other devices (e.g., security platform 104) are computing devices, such as servers, client computers, desktop computers, mobile computers, etc. The computing device 102 and/or security platform 104 can be implemented via a processing element, memory, and/or other components.

The computing device 102 includes, for example, a processor 110, and a machine-readable storage medium 120 including instructions 122, 124, 126 for performing passive security on the device. As noted, computing device 102 may be, for example, a notebook computer, a slate computing device, a portable reading device, a wireless email device, a mobile phone, a server, a workstation, a special purpose machine, or any other computing device.

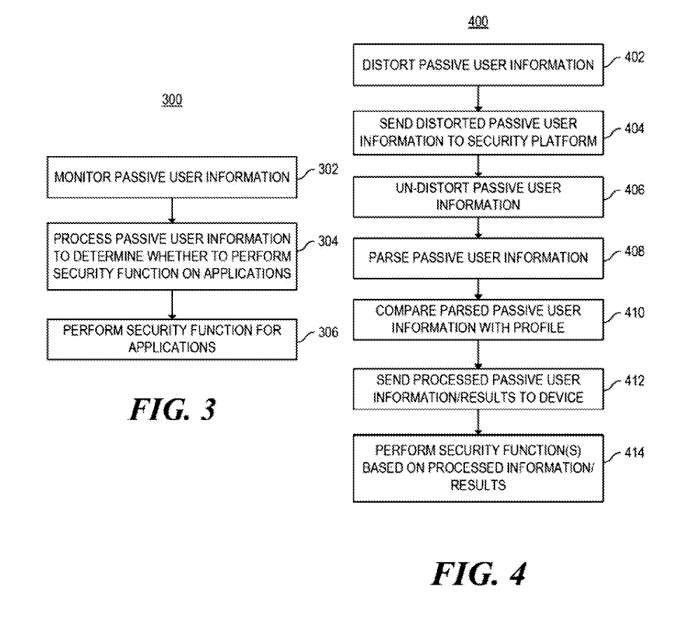

Processor 110 may be, at least one central processing unit (CPU), at least one semiconductor-based microprocessor, at least one graphics processing unit (GPU), other hardware devices suitable for retrieval and execution of instructions stored in machine-readable storage medium 120, or combinations thereof. For example, the processor 110 may include multiple cores on a chip, include multiple cores across multiple chips, multiple cores across multiple devices (e.g., if the computing device 102 includes multiple node devices), or combinations thereof. Processor 110 may fetch, decode, and execute instructions 122, 124, 126 to implement the approaches of FIGS. 3 and/or 4. As an alternative or in addition to retrieving and executing instructions, processor 110 may include at least one integrated circuit (IC), other control logic, other electronic circuits, or combinations thereof that include a number of electronic components for performing the functionality of instructions 122, 124, 126.

Machine-readable storage medium 120 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 120 may be encoded with a series of executable instructions for providing passive security for the computing device 102.

One or more applications can be executed by the computing device 102. In some examples, the applications are different from an operating system which may also be executing on the computing device 102. In one example, an application is executable instructions or software that causes a computing device to perform useful tasks beyond the running of the computing device itself. Examples of applications can include a game, a browser, enterprise software, accounting software, office suites, graphics software, media players, project engineering software, simulation software, development software, web applications, standalone restricted material applications, etc. The application software can be passively secured using a passive security. Moreover, a plugin or other code may be used to transform a general use application into a restricted material application used to view restricted content. In some examples, a web application is an application that is accessed by users over a network such as an intranet, the Internet, etc. Further, a web application can be coded in a browser-supported programming language. A standalone restricted material application can be an application, such as a browser or content providing application that can work without modification with the passive security engine.

In one example, applications of the computing device 102 can be configured to be associated with a passive security engine. In some examples, the engine can be located on the security platform 104, such as passive security engine 130 (e.g., via a client/server relationship). In other examples, one or more parts of the passive security engine 130 can be implemented on the computing device 102, for example, via passive security instructions 122. The applications can be configured via one or more instructions or code. The code can include plug-ins or other modules to add security features to the application (e.g., a web browser, an office suite, etc.). As such, passive security can be implemented at the application level, at the content level, and/or at the level of a portion of the application implementing the passive security.

In some examples, the passive security instructions 122 can be executed to cause monitoring of the computing device 102 and to process the monitored information. Monitoring instructions 124 can be executed by the processor 110 to use one or more devices to monitor passive information, for example, information about the user of the computing device 102. In some examples, the passive security instructions 122 are used to provide the passive information to the passive security engine 130. In other examples, the passive security engine can be implemented at the computing device 102 via the passive security instructions 122.

Code can be implemented to collect information from one or more inputs 128. The inputs 128 can be from devices communicatively connected to the computing device 102 (e.g., via a wireless connection, a wired connection, etc.). Moreover, the input devices may be integrated in the computing device 102.

During execution of the application(s), passive security engine 130 can associate the user with a profile. This can be done, for example, by logging (e.g., user name and password, biometric information, a key, etc.) into the computing device 102, the application(s), a passive security agent on the computing device 102, etc. The profile can be built via a tool that takes in baseline information (e.g., an employer may take fingerprints, a retina scan, etc. and upload to the database), via machine learning (e.g., processing typing patterns, voice patterns, etc.), or the like. As such, the passive security engine can be configured for a particular user. The profile can include information that can be used to check the collected passive information about the user. This can include unprocessed information, such as an encrypted or unencrypted picture of the user and/or processed information, such as nodal points of the face of the user processed from an image.

Further, during execution of the application(s), information passive user information collected via the executed monitor instructions 124 can be processed by the passive security engine. As noted, one or more devices can be monitored to collect passive user information, for example, as input 128. Examples of devices for monitoring can include one or more image sensors (e.g., a camera, infrared sensor, etc.), one or more scanners (e.g., a palm print scanner, a fingerprint scanner, etc.), a user input (e.g., mouse, keyboard, etc.), biometric sensors (e.g., heart sensors, brain sensors, embedded chips, etc.), voice sensors (e.g., a microphone), sensors to monitor movement, a key (e.g., a Bluetooth key, a USB key, etc.), or the like.

Usage of input devices can be controlled by the monitor instructions 124. In one example, one or more of the input devices may continuously take readings, which can be formatted, tagged, and stored. An example of such an input device may be a keyboard input, where the typing rhythm of the keyboard is analyzed to determine the likelihood that the user is the authenticated user. In other examples, input devices may be continuously on, but a snapshot of the device information may be taken based on a predetermined or periodic time or interrupt. For example, a picture of a person's face for face recognition may be taken at a predetermined time or when additional motion is sensed. The additional motion can be sensed using another input device or based on an analysis of the information at the input device. In further examples, an input device may turn on periodically or based on an interrupt to take a reading. Different types of readings can be formatted, tagged, and stored using different approaches.

Information monitored by the inputs can be caused to be processed at the passive security engine. As noted, one or more parts of the passive security engine may be implemented on the computing device 102, or the passive security instructions can cause the passive security engine 130 of a security platform 104 to process the information. In the example of an external passive security engine 130, the computing device can distort the passive user information to generate distorted passive user information. In some examples, an encrypting mechanism can be used to distort the passive user information. In the example of encrypting, the passive security engine 130 may have information to decode the distorted passive user information. The distorted passive user information or undistorted passive user information can be sent to the passive security engine. In some examples, the passive user information can be sent to a local passive security engine. Further, the local information may be stored distorted to improve user privacy/security. The information can be processed at the passive security engine and processed passive user information can be received.

The passive security engine can process the passive user information via one or more functions. In certain examples, the functions can be customized for an application, particular content, particular information available, or the like. The customization can be based on one or more rules associated with the respective applications/content. In some examples, the rules can be provided to the passive security engine (e.g., from the respective application).

The function can take into account the passive user information available, the profile, as well as the rules to determine a result. In certain examples, the result can be Boolean stating whether the engine believes that the proper user is still at the computing device. In other examples, the results can include more granularities. For example, the passive search engine can produce a score based on the information. The score may, for example, be based on one or more weighting factors or rules. These rules/weighting factors may be specific to an application/content or may be general. In one example, the rules/weighting factors can be associated with how likely the passive information can properly detect whether an individual near the computing device 102 is the authorized user.

In one example, the score can be out of 100. This is for example purposes and it is noted that the score may be variable based on usage. Each type of passive user information can be associated with a value out of the 100 score. For example, a retina scan can be worth 40 points, a fingerprint can be worth 20 points, facial recognition can be worth 20 points, and a digital key associated with the user can be worth 20 points. In certain examples, these point values can be determined by analyzing the passive user information as compared to the profile. Further, a confidence factor may be used to show how likely the passive user information is correct. For example, if in a fingerprint determination, 20 points of the finger are matched out of 25, full points may or may not be given to the score.

Further, weighting factors can be based on the context of the computing device 102. For example, if the computing device 102 has a camera attached for facial recognition, the resolution of the camera can affect the maximum amount of points available for the score.

In certain examples, the score can be provided to the applications as results. In other examples, the score can be processed at the passive security engine to provide the applications with other types of results, for example, provide access, do not provide access, or more information needed. As such, the respective applications and/or the passive security engine can do the analysis to determine the results or other processed results.

In one example, the application can be associated with a threshold score that allows the user to be provided access. As an example, the threshold can be 80/100 score points. If this threshold is met, the user is continued to be provided access. In another example, another threshold can be set to request more information or further analysis. For example, if the score is between 60 and 80, additional analysis can be performed and/or more information can be taken to perform the analysis. Additionally, other types of passive user information can be checked. For instance, the example above did not take into consideration a vocal input, additional analysis can take into account such information. Moreover, an active function may be requested of the user. For example, the user may be asked to look into a camera for a more focused retina or facial scan. In another example, the user may be asked to authenticate again.

Different applications on the computing device 102 can be associated with different thresholds. As such, one application on the computing device 102 may have a threshold that passes and is allowed access, while another application may have a threshold that fails and the user is logged out or otherwise deprived of access, while yet another application/associated content can attempt a more thorough check on the user (e.g., ask the user to provide a finger print scan). Moreover, the thresholds of the respective applications can be dynamic based on content being provided (e.g., some content may be associated with additional security) and/or the context of the computing device 102 or user. For example, if the computing device is at a work location, a lower threshold may be used than if the user was home. In another example, if the computing device was at another unknown location (e.g., a coffee shop), the threshold may be higher. Location context can be based on various technologies, for example, analysis of an Internet Protocol (IP) address, analysis of location information (e.g., using cellular tracking, global positioning information, etc.). Other contextual information may be the time. For example, if the computing device is used during normal working hours for the user, the threshold may be lower than if the computing device was used at off hours. Moreover, the amount of times the user is passively checked can depend on the context. For example, a normal time period or more secure location can lead to less frequent checks.

A security function can be performed by one or more of the applications based on the results of the passive security engine, for example, by executing security function instructions 126. In some examples, the security function instructions can be included as part of a plugin of an application and/or as part of the application itself. As noted above, security functions can include disallowing access to the application, continuing to allow access to the application, asking for the user to provide credentials, providing additional passive information to the passive security engine for additional checking, or the like.

As such, processed passive user information processed by the passive security engine can include results as to whether one of the applications should be allowed continuing access. Moreover, the results or other results can be used to determine whether another application should be allowed continuing access. The results for the two applications can be different based on the same processed passive user information. As noted, the results can be explicit meanings or can be a score that the particular application can process internally to determine respective security functions. In some examples, a source of the content/application can determine the security functions to use and/or the authentication requirements. These can be implemented via a plugin or other code.

In some examples, a part of one application can be disabled, while another part is allowed (e.g., a web browser with two separate sites open, an office application with two documents open, etc.). This can be based on analysis done at the passive security engine and/or at the application. Moreover, content associated with the part can be targeted.

The communication network 106 can use wired communications, wireless communications, or combinations thereof. Further, the communication network 106 can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network 106 can be in the form of a direct network link between devices. Various communications structures and infrastructure can be utilized to implement the communication network(s).

By way of example, the computing device 102 and security platform 104, and/or other devices communicate with each other and other components with access to the communication network 106 via a communication protocol or multiple protocols. A protocol can be a set of rules that defines how nodes of the communication network 106 interact with other nodes. Further, communications between network nodes can be implemented by exchanging discrete packets of data or sending messages. Packets can include header information associated with a protocol (e.g., information on the location of the network node(s) to contact) as well as payload information. Information exchanged between the computing device 102 and the security platform 104 can be encrypted, for example, using RSA 128 bit encryption or another type of encryption.

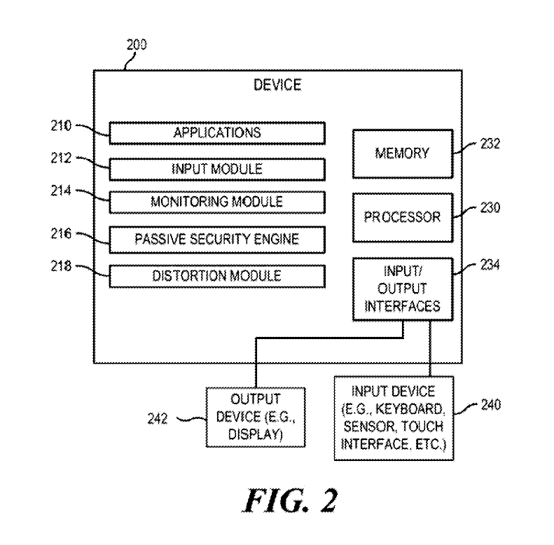

FIG. 2 is a block diagram of device capable of performing a security function on applications, according to one example. In this example, the device 200 includes one or more applications 210, an input module 212, a monitoring module 214, an implicit passive security engine 216, a distortion module 218, a processor 230, memory 232, and input/output interfaces 234. Other components can also be included or otherwise connected to the device 200, for example, input devices 240 and/or output devices 242.

As with computing device 102 of FIG. 1, device 200 may be a notebook computer, a slate computing device, a portable reading device, a wireless email device, a mobile phone, a workstation, a piece of machinery, or any other computing device capable of performing a security function based on passive user information. Processor 230 may be a CPU, GPU, or microprocessor suitable for retrieval and execution of instructions and/or electronic circuits configured to perform the functionality of any of the modules 210, 212, 214, 216, 218 described herein.

One or more applications 210 can be present on the device 200. One or more of the applications 210 can execute simultaneously. Further, the applications can be associated with a passive security engine 216. The passive security engine 216 can implicitly rate the likelihood of whether a user of the device 200 is a user that has authenticated into an account, an application, etc. This information can be used to determine whether to provide the user access to an application and/or content. Moreover, the applications may include a web application, a standalone restricted material application, combinations thereof, etc.

An input module 212 can control input/output interfaces 234 to receive input from one or more input devices 240. In some examples, the input devices can include sensors. A sensor is a converter that measures a physical quantity and converts it into information that can be read by the device. Examples of sensors include image sensors such as cameras, print scanners (e.g., fingerprint/palm print scanners, etc.), retina scanners, etc., audio scanners such as a microphone, navigational sensors (e.g., global positioning system, etc.), movement sensors, proximity sensors, touch sensors (e.g., keyboards, touch screen sensors, etc.), etc. The sensors and/or other input devices 240 can be integrated into the device 200 or be attached via another mechanism (e.g., wireless signal, a cable, etc.).

The monitoring module 214 can monitor passive user information via the inputs. The passive user information can be formatted into a format that the passive security engine 216 understands and be sent to the passive security engine 216. In some examples, the format may be distorted using a distortion module 218. In some examples, the passive security engine 216 can be implemented completely on the device 200. In other examples, a component of the passive security engine 216 can be local and be used to send passive user information to another platform for processing as further described in FIG. 1.

The passive security engine can determine whether to perform a security function on the applications. In one example, the passive security engine can be used to determine at least two separate security functions for different applications based on the passive user information. In some examples, the decisions can be made via a plugin or specific code running on the respective applications.

In one example, the security function used on an application is based on a function of the passive user information and rules associated with the respective application. For example, the passive user information and rules can be used to generate a score for the likelihood that the user is a particular person (e.g., as part of a function called). The score can then be used by the respective application to determine a proper security function to perform (e.g., allow the user continuing access, restrict access to content or an application, request more information or security checks (implicit or explicit), or the like).

Moreover, a security level of the respective applications can be used to determine the security function. For example, a first application or content of the application may be associated with a first security level. That security level may require a particular score (e.g., a threshold) to continue access. Moreover, the security level can be used to determine what passive user information is collected and/or used at the passive security engine 216. Further, in certain scenarios, the security level may be used to change how much weight a particular type of information has in the score. As further detailed above, a score and/or other results can be the output of the passive security engine 216 to the application(s) 210.

As detailed herein, device 200 may include a series of modules 210, 212, 214, 216, 218 for performing the methods of FIGS. 3 and 4. Each of the modules 210, 212, 214, 216, 218 may include, for example, hardware devices including electronic circuitry for implementing the functionality described herein. In addition or as an alternative, each module may be implemented as a series of instructions encoded on a machine-readable storage medium of device 200 and executable by processor 230. It should be noted that, in some embodiments, some modules are implemented as hardware devices, while other modules are implemented as executable instructions.

FIG. 3 is a flowchart of a method for performing a security function for applications, according to one example. Although execution of method 300 is described below with reference to device 200, other suitable components for execution of method 300 can be utilized (e.g., computing device 102). Additionally, the components for executing the method 300 may be spread among multiple devices. Method 300 may be implemented in the form of executable instructions stored on a machine-readable storage medium, such as storage medium 120, and/or in the form of electronic circuitry.

Applications can be configured to execute on the device 200. The user of the device may log into one or more accounts associated with respective applications. The accounts and/or applications may be associated with a passive security engine 216. Examples of applications can include a web application, a standalone restricted material application, a document viewer or modifier, or the like.

At 302, a monitoring module 214 is used to monitor passive user information via multiple inputs to the device 200. As noted above, the monitoring can include processing passive user information. The passive user information can be monitored from inputs, such as sensors, other electronics devices, etc.

At 304, the device 200 can cause processing of the passive user information at the passive security engine. The processing can be done at the device 200 or can be sent to another platform for processing at the platform and receiving results of that processing as further detailed in FIG. 4. The processed information or results can be used to determine whether to perform a respective security function for one or more of the applications executing on the device 200. The processed information can also be based on a determination of whether the device is secure. In some examples, the device can be considered secure if a user of the device 200 matches a profile associated with the passive security engine.

As noted above, the processing can result in a score that can be used by the respective applications and/or other information (e.g., a Boolean value or action to take) that can be used by the respective applications to perform respective security functions (306). Security functions can be performed at two or more of the applications.

In one example, a user can navigate to a corporate application that includes sensitive financial data. This could trigger a passive face recognition authentication of the user on a frequency of every 2 minutes, while accessing corporate email may only require an initial authentication and intermittent validation of presence by typing pattern or proximity sensor. Access to external or non-critical sites could be allowed with no additional authentication.

In some examples, the passive security engine can be used to perform the initial authentication as well. For example, the device may be associated with one or more profiles associated with the passive security engine. The passive security engine can take information about a user and compare to the set of profiles to determine whether the user should be allowed access. This can be useful, for example, in a lab setting or family setting, where multiple people can have legitimate access rights to the device.

Further, in some examples, the electronic representation of the security credentials used by this platform are cancellable (can be reset), this is accomplished by distorting the electronic representation of the security credentials (e.g. fingerprints). Distortion of the electronic representation of the security credentials helps security by accounting for the possibility that the information can be stolen. If it is determined that the information has been stolen, the security credentials can be reset. In some examples, resetting may include using a new encrypted sample for comparison purposes.

FIG. 4 is a flowchart of a method for processing passive user information for performing a security function, according to one example. Although execution of method 300 is described below with reference to computing device 102, other suitable components for execution of method 300 can be utilized (e.g., device 200). Additionally, the components for executing the method 300 may be spread among multiple devices. Method 300 may be implemented in the form of executable instructions stored on a machine-readable storage medium, such as storage medium 120, and/or in the form of electronic circuitry.

The computing device 102 can monitor inputs to determine passive user information. The passive user information can be distorted at 402. As noted above, this can be done by encrypting the passive user information (e.g., using public-key cryptography). The computing device 102 can then send the distorted passive user information to a security platform 104 (404).

A passive security engine 130 of the security platform 104 can process the distorted passive user information. The processing can include un-distorting the information (406) and determining a score associated with how likely the user of the computing device 102 is a particular user and/or is a secure (e.g., the user may not be considered secure if it is detected that someone is next to the user). As noted above, the passive security engine 130 can capture a sample and associate the sample with a profile. Then, the passive security engine 130 can extract unique data from the sample, e.g., to create a template. During processing of the passive user information, the passive security engine 130 can parse the passive user information (408) into differing types (e.g., fingerprint, typing analysis, retina, electronic key, etc.). Further, each of the parsed information can be compared to a respective template and the passive security engine 130 can determine whether the features extracted from the new sample match or not (410). One or more algorithms can be used for each type of input processing used. The matching process can also determine a confidence of how likely the matching is correct. This can be used, for example, to score the each of the different types of passive checks. In some examples, the scoring can be based on the quality of the equipment, the amount of matching that occurred. For example, a facial recognition scan may have 80 nodal points, of which 65 nodal points matched. This example may end in a positive match, but a better positive match may occur if 75 of the 80 points matched. On the other hand, a match of 30 out of 80 nodal points may end up as a failure and lead to zero points. As such, the amount of matching can affect the score and the amount of the affect need not be linear.

Then, at 412, the security platform 104 can send the processed passive user information and/or results back to the computing device 102. The processed passive user information can be distorted or un-distorted.

Then, the computing device 102 can receive the processed passive user information. As noted above, the processed passive user information can be in the form of a score or a likelihood that the computing device 102 is secure. In some examples, the likelihood can be separated into one or more levels that can represent associated security functions. For example, one level can be associated with continuing to allow an application to execute and provide content, a second level can be associated with stopping access to content at an application, and a third level can be associated with gathering additional passive information or an explicit authorization. At 414, respective applications can perform a security function based on the processed information/results. In some examples, a single application (e.g., a web browser) may use the processed information/results to perform multiple security functions. For example, an email application may be allowed continuing access, while a secured financial statement website may be logged out.

With the above approaches implicit passive security can be performed on a device based on implicit passive checks, such as, but not limited to, facial recognition, retina scans, voice input, typing patterns, etc. that can be done at set intervals, randomly, or based on an interrupt and can dynamically control content and/or applications that an end user can access/view in real-time. The implicit passive security checks can be configurable for certain content and/or applications so that more and/or less passive security checks can be performed dynamically in real-time. The passive security checks can also be based on context awareness of the device. For example, if the device is at a work location, less implicit checks may be performed or a lower threshold may be used to evaluate the checks.

1. A non-transitory machine-readable storage medium storing instructions that, if executed by at least one processor of a device, cause the device to:
configure a plurality of applications of the device to be associated with an passive security engine;
monitor passive user information via a plurality of inputs to the device;
cause processing of the passive user information at the passive security engine;
perform a respective security function for at least two of the applications based on the processed passive user information; and
to repeat the monitoring, the causing and the performing at defined intervals, at random intervals or based on interrupts.

2. The non-transitory machine-readable storage medium of claim 1, further comprising instructions that, if executed by the at least one processor, cause the device to:
distort the passive user information to generate distorted passive user information;
send the passive user information to a security platform; and
receive the processed passive user information.

3. The non-transitory machine-readable storage medium of claim 1, wherein the processed passive user information includes respective results as to whether the respective applications should be allowed access, the respective results being respective scores or being provided by processing the respective scores, the respective scores being based on the passive user information and one or more weighting factors or rules associated with the respective applications.

4. The non-transitory machine-readable storage medium of claim 3, wherein the respective security functions are performed based on the respective results.

5. The non-transitory machine-readable storage medium of claim 4, wherein the respective results are obtained based on the respective scores and respective thresholds associated with the respective applications, and wherein the respective thresholds are dynamic based on one of content being provided and context of the device.

6. The non-transitory machine-readable storage medium of claim 5, wherein the context of the device includes at least one of a location of the device, and a time when the device is used.

7. (canceled)

8. The non-transitory machine-readable storage medium of claim 6, wherein the weighting factors are based, at least in part, on the context of the device.

9. The non-transitory machine-readable storage medium of claim 1, wherein the passive user information includes at least one of: user print information, user retina information, user face recognition, user voice recognition, keystroke information, and an electronic key.

10. A method comprising:
monitoring passive user information via a plurality of inputs to a device including a plurality of applications configured to be associated with an passive security engine;
causing processing the passive user information at the passive security engine to determine whether to perform a respective security function for the respective applications, wherein the processed passive user information is further based on determining whether the device is secure;
performing the respective security function for at least two of the applications based on the processed passive user information; and
repeating the monitoring, the causing and the performing at defined intervals, at random intervals or based on interrupts.

11. The method of claim 10, wherein the processed passive user information includes respective results as to whether the respective applications should be allowed access, the respective results being respective scores or being derived by processing the respective scores, the respective scores being based on the passive user information and one or more weighting factors or rules associated with the respective applications.

12. The method of claim 10 wherein, the passive user information to includes at least one of user print information, user retina information, user face recognition, user voice recognition, keystroke information, and an electronic key.

13. A computing device comprising:
a plurality of applications to be associated with a passive security engine;
an input module to receive a plurality of inputs, wherein an input includes a sensor;
a monitoring module to monitor passive user information via the inputs;
the passive security engine to process the passive user information to determine whether to perform a respective security function for at least two of the applications based on the passive user information, wherein the respective security functions for the at least two of the applications are different from each other; and
wherein the monitoring, the processing, and the determining are repeated at defined intervals, at random intervals or based on interrupts.

14. (canceled)

15. (canceled)

16. The computing device of claim 13, wherein the processed passive user information includes respective results as to whether the respective applications should be allowed access, the respective results being respective scores or being derived by processing the respective scores, the respective scores being based on the passive user information and one or more weighting factors or rules associated with the respective applications.

17. The non-transitory machine-readable storage medium of claim 1, wherein the applications include at least one of: a web application and a standalone restricted material application.

18. The method of claim 10, wherein the applications include at least one of: a web application and a standalone restricted material application.
